(19) United States
(12) Patent Application Publication
(10) Pub. No.: US 2008/0096587 A1
(43) Pub. Date: Apr. 24, 2008

(54) Telephone for Sending Voice and Text Messages

(76) Inventor: Peter Rubinstein, Victoria (AU)

Correspondence Address: STITES & HARBISON PLLC, 1199 NORTH FAIRFAX STREET, SUITE 900, ALEXANDRIA, VA, 22314, US

(21) Appl. No.: 10/592,478

(22) PCT Filed: Mar. 11, 2005
(86) PCT No.: PCT/AU05/00352

§ 371 Date: Aug. 20, 2007

Related U.S. Application Data
(60) Provisional application No. 60/551,770, filed on Mar. 11, 2004.

(51) Int. Cl. H04Q 7/20

(52) U.S. Cl. 455/466

(57) ABSTRACT

A Communications apparatus, comprising a memory for storing message data comprising a plurality of predefined message blocks, a data processor in data communication with the memory, and a program executable by the data processor to retrieve any of the predefined message blocks and to control the apparatus to transmit a message block so retrieved. The program and hence the apparatus is controllable by a user to select at least one of the predefined message blocks and to transmit or initiate transmission of the selected at least one message block.

### RELATED APPLICATION

This application is based on and claims the benefit of the filing date of U.S. application Ser. No. 60/551,770 filed 11 Mar. 2004, the contents of which are incorporated herein by reference in its entirety.

### FIELD OF THE INVENTION

The present invention relates to a communications device or apparatus, and in particular a telephone, for sending voice, text and other prerecorded messages, and to a program for use in such a communications device or apparatus.

### BACKGROUND OF THE INVENTION

One existing technique for sending messages from a telephone is the short messaging service (or SMS), with which a user can compose a brief message on a mobile telephone for transmission to another person's telephone.

U.S. Pat. No. 6,292,799 discloses a voice mail system that facilitates replying to a voice message left by a caller by identifying the caller and retrieving the caller's address from a database. The caller is identified by searching a database by means of a voice signature of the caller.

### SUMMARY OF THE INVENTION

In a first broad aspect, the invention provides a communications apparatus, comprising:
a memory for storing message data comprising a plurality of predefined message blocks;
a data processor in data communication with said memory; and
a program executable by said data processor to retrieve any of said predefined message blocks and to control said apparatus to transmit a message block so retrieved;
wherein the program is controllable by a user to select at least one of the predefined message blocks and to transmit or initiate transmission of the selected message block.

Preferably the program is operable by the user when an incoming call or incoming message is received by the apparatus to transmit a response to the incoming call or message comprising the selected message block.

In a particular embodiment, the apparatus is in the form of a device that houses the memory, data processor and program. However, it will be appreciated that the various components of the need not be housed together. For example, the apparatus may employ memory located on a common telecommunications network and hence accessible to the data processor. The program may comprise a number of components, with one or more in a handset and one or more other components located on a common telecommunications network.

In one embodiment, the program is operable to initiate a call.

Preferably the communications apparatus is a portable communications device; more preferably the apparatus is a telephone.

However, the apparatus can comprise any communications apparatus, including a suitably equipped personal digital assistant (PDA), camera or computing device.

In one embodiment, the apparatus is a mobile telephone, such as a digital telephone for use in a cellular telephony network according to any telephony protocol.

Preferably the program is operable by the user to select and transmit a plurality of the predefined message blocks in response to the incoming call or message.

Thus, a user can concatenate a plurality of the predefined message blocks and thus compose—as required—a longer message for transmission. It should be understood, also, that a message block can comprise a single word, so that the concatenation of a plurality of predefined message blocks can comprise composing a message from individual words.

The predefined message blocks may be in the form of audio (typically voice) message data so that, when transmitted, the selected message block is audible to the maker of the incoming call or sender of the text message.

Alternatively, the predefined message blocks may be in the form of text message data so that, when transmitted, the selected message block is received by the maker of the incoming call or sender of the text message as a text message.

Alternatively, the predefined message blocks may include both audio message data and text message data so that, when transmitted, the selected message block is received by the maker of the incoming call or sender of the text message as both an audible message and as a text message.

Thus, a message block can be in any suitable format (including audio, text, video and multimedia). If text or voice, a message block can comprise a single word, a phrase or a complete message. Indeed, a message block can comprise an individual letter or syllable, typically for concatenation with other message blocks into a word or words. In such cases, the program may delay processing and transmitting the ultimate message until sufficient message blocks have been selected to constitute the completed word or phrase.

An incoming message may comprise a text message (such as according to the SMS protocol), a video message, a mixed media message, or otherwise.

In one embodiment, the program includes voice synthesis code for interpreting message blocks, synthesizing a synthesized voice message therefrom and controlling the apparatus to transmit the synthesized voice message.

The program may be in the form of software or embodied as hardware.

A predefined message block may comprise or include other data, such as video data, according to the technical specifications of the apparatus (e.g. telephone) or telecommunications system (e.g. telephony system) with which the apparatus is used.

Preferably the apparatus (generally via the program) is controllable by means of keys of the apparatus, whereby a respective one of the predefined message blocks is retrieved in response to operation of a respective one of such keys (or a pair or other combination—that is, depressed in combination—of keys).

Hence, the user can respond to a call (or text message) by selecting and operating, preferably, a single key. This allows the user to respond to an incoming call or message from—in effect—a menu of messages. As will be appreciated by those in the art, the user may be listen to a call by means of a peripheral device, such as a hands free device, an ear piece or detached speaker (any of which can be connected to the apparatus wirelessly or by cable). Thus, a two way conversation can be held.

In one embodiment, the apparatus (generally via the program) is operable by the user to store the predefined message blocks, whether by storing audio message blocks spoken into or transmitted to the apparatus, text message blocks entered into or transmitted to the apparatus, video message blocks recorded into or transmitted to the telephone, or otherwise. The message blocks may ultimately be stored on the apparatus (such as a telephone) or in remote storage accessible by the apparatus via a telecommunications network. This network will commonly be a mobile telephone network.

Thus, predefined message blocks could be stored by the user or downloaded for a library of such messages. In addition, downloaded message blocks could also be recorded by celebrities to provide a novel or amusing effect.

In one embodiment, the program is operable by the user while the apparatus (such as a telephone) is announcing the incoming call (such as by ringing, vibrating or flashing lights). More preferably the program is operable by the user operating a single key or combination of keys to answer the incoming call thereby establishing a telephony connection, and to transmit the response to the incoming call, whereby the maker of the incoming call receives the selected message block.

Preferably the program is configured to terminate the telephony connection after the response has been transmitted to the maker of the call.

In another embodiment, the program is operable by the user while or soon after the telephone is announcing (such as by ringing, vibrating or flashing) the incoming message.

Preferably the apparatus includes voice recognition software that is operable (in one embodiment, by being executed on the apparatus) to convert any voice content of an incoming telephone call to text for display by the apparatus.

Thus, this enables the user to read the content even in noisy environments (such as nightclubs) or in environments where listening to the content would be deemed unacceptable (such as when the user is in an unrelated meeting). The user can then respond to the caller using the other features of the invention, such as by selecting and transmitting to the caller one or more of the predefined message blocks. The resulting conversation is silent from the user's perspective, but the caller can speak normally. Indeed, if the caller has a comparable apparatus according to the invention having voice synthesis code, the caller can engage in a two-way voice conversation even though the user is unable to speak.

In a second broad aspect, the invention provides a program as referred to above, loadable into a telephone and executable as described above.

In a third broad aspect, the invention provides a communications apparatus, comprising:
a memory for storing message data comprising a plurality of predefined message blocks; and
a data processor in data communication with the memory;
wherein the apparatus is operable by a user to retrieve at least one of the predefined message blocks and to transmit the selected message block.

In another broad aspect, the invention provides a method of transmitting a message from a communications apparatus, comprising:
storing message data comprising a plurality of predefined message blocks in a memory of the apparatus; and
selecting at least one of the predefined message blocks; and
controlling the apparatus to retrieve and transmit the selected predefined message block.

### BRIEF DESCRIPTION OF THE DRAWING

In order that the invention may be more clearly ascertained, an embodiment will now be described, by way of example, with reference to the accompanying drawings, in which:

FIG. 1 is a view of a telephone according to an embodiment of the present invention;

FIG. 2 is a schematic diagram of blocks of the telephone of FIG. 1; and

FIG. 3 is a view of the keypad of the telephone of FIG. 1.

### DETAILED DESCRIPTION

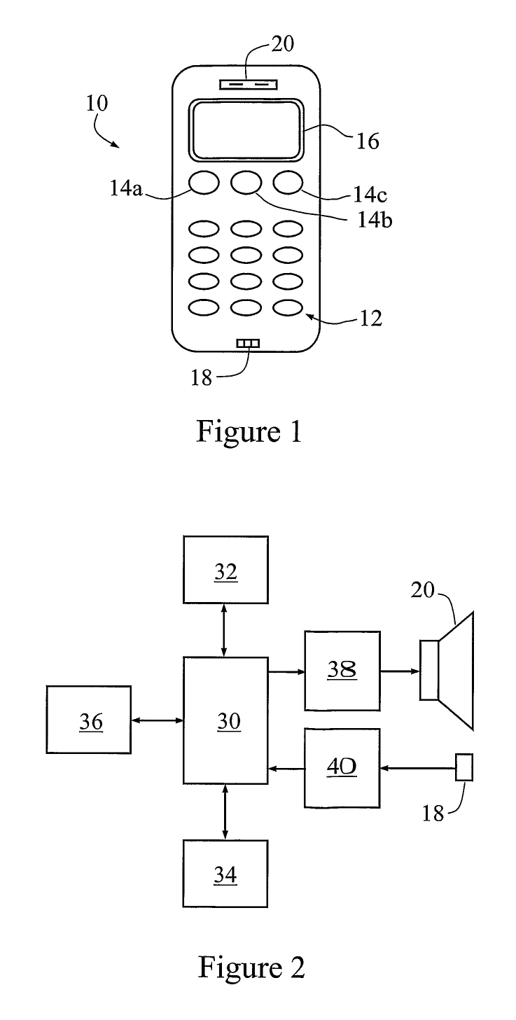

A mobile telephone according to an embodiment of the present invention is shown generally at 10 in FIG. 1. The telephone 10 includes a numerical keypad 12, a number of control keys 14a, 14b, 14c (including a menu key 14a), a display 16, a microphone 18 and a speaker 20.

FIG. 2 is a schematic diagram of the blocks of telephone 10 pertinent to this invention, including central processing unit (CPU) 30, memory 32, transceiver 34 (comprising antenna, transmitter and receiver), user interface 36 (comprising keypad 12, control keys 14a, 14b, 14c, and display 16), sound generator 38, speaker 20, microphone 18 and ADC 40. The transceiver 34 operates in the usual manner for transmitting and receiving voice, data and other transmissions over the mobile telephony network. Voice transmissions and other audio signals are output via sound generator 38 and speaker 20, while microphone 18 captures audio input, and passes such input through ADC 40 to CPU 30.

Memory 32 schematically represents the entire memory of the telephone, including both random access memory and read only memory. The appropriate type of memory to be used in any particular instance will be understood by those in the art so no distinction is made between these two forms of memory in the following discussion.

According to the present embodiment, memory 32 is also provided with software (either installed at manufacture or subsequently downloaded) and message data forming a set of predefined message blocks. Some of the message blocks are in the form of audio files, each corresponding to a brief voice message, while others are in the form of text message blocks. These message blocks can have of any desired content, but in this embodiment the message blocks are designed to be transmitted (as is described below) when the user is unable to speak to a caller or respond to a text message. For example, such message blocks could include: “Please”, “I will”, “call back”, “shortly”, “tonight”, “tomorrow”, “I am presently busy—please call back in a few minutes”, “I will respond as soon as possible”, “I am in a meeting”, “I can't speak, please give me a quick summary” or “I am in the theatre, can't talk now, is there anything urgent?“. In case the user receives an unsolicited text message (comparable, for example, to span email), it may be useful to include the message block “please remove me from your database”. A predefined message block for indicating to a caller that a fuller response is being prepared is “please wait, I cannot speak: I am typing a text message.”

It will be noted that some of the message blocks comprise single words, while other comprise complete phrases.

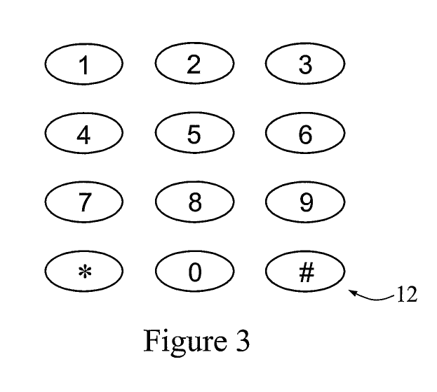

In the case of both audio and text message blocks, the message blocks may be loaded into memory 32 during manufacture, but importantly they can also be stored in the memory 32 by the user. Each message block is assigned to one of the keys on numerical keypad 12 (as shown in FIG. 3). Thus, the software is operable by the user by means of the keypad 12 to transmit any one or more of the message blocks in response to an incoming call or upon receipt of a text message.

In this embodiment, when the telephone 10 rings, the software is automatically activated so as to activate the keys of the keypad 12. Rather than operating the phone to answer the call in the customary manner, the user selects one of the predefined audio message blocks by depressing one of the keys on keypad 12, specifically that key to which the selected message block has been assigned. The user interface 36 sends the appropriate command signal to the CPU 30 and the software controls the CPU 30 to answer the call, retrieve the data corresponding to the selected message block from the memory 32, process that data and output a corresponding signal for transmission to the transceiver 34. The message block is thus transmitted to the caller in place of a live user response.

The software does not automatically terminate the connection as the caller may wish to respond and, if the user—even though occupied—can hear the caller (perhaps by using a peripheral device such as a hands free device, an ear piece or detached speaker, any of which can be connected to the device wirelessly or by cable), the user may respond again by the same procedure.

A simple conversation is then possible, limited by the range of message blocks stored previously by the user or manufacturer in the telephone 10. As will be appreciated, the caller may hang up and this, when detected by the telephone 10 or telephony network, prompts the termination of the connection. Alternatively, the software can be configured to operate in a mode where the connection is terminated after the message block or blocks are sent. In another mode, the connection is terminated but the caller is transferred to another number, such as a voicemail service. It will be understood, however, that in the last example, the present invention has the advantage (when compared with existing voicemail services) that the user selects what message block will be received by the caller before that caller is transferred to voicemail, whether or not a conventional voice mail message is then played to the caller.

This would also allow, for example, the speech impaired to communicate by telephone without having actually to speak, and in one embodiment the telephone is a fixed line telephone for domestic use by such users.

If a text message is received, essentially the same procedure is followed except that the telephone 10 need not be answered; the user selects one or more text message blocks, which are simply sent as a text message to the sender of the incoming text message.

It should be noted that, even if a call is received, the user can elect to send a text message. Doing so prompts the software to terminate the call without answering but to then send the selected text message block or blocks to the number of the incoming call. In addition, the user can control the program so that incoming calls are intercepted and automatically answered, a message (whether, text, audio or otherwise) is automatically selected according to the origin of the incoming call (as identified by the caller's number) and transmitted to the caller. This could be described as a form of personalized voice mail. The message may include instructions to the caller, such as to activate particular keys according to the purpose of the call. The telephone can then either automatically disconnect, or keep the connection open for further interaction such as a continuation of the conversation.

Further, the software may employ pre-existing key assignments, such as in those embodiments were a message block can comprise an individual letter and each key on numerical keypad 12 has one or more alphabetical assignments (possibly assigned by the manufacturer). Indeed, such embodiments can employ existing text messaging key assignments and predictive text techniques so that a message can be composed by a user much he or she would a conventional text message, but then have that message either sent as text or “read” (by assembling and transmitting predefined audio message blocks or by means of voice synthesis code, as described below) to the caller. A conversation can then be conducted with the caller using voice or text, but the user (or respondent) responding silently.

In one embodiment, two versions of each message block are stored in memory 32, a first version as audio and a second version as text. As a result, the user is not required to select a voice message block or blocks for an incoming call and a text message block or blocks for a received message. The user need only select the message block or blocks according to content. If the software detects that this is in response to an incoming call, the software controls the CPU 30 to answer the call, retrieve the relevant audio version of the selected message block or blocks and transmit that audio content as described above. If, on the other hand, the software detects that there is no incoming call but that a text message has just been received, the software controls the CPU 30 to retrieve the relevant text version of the selected message block or blocks and transmit that content as a text message to the origin of the received text message.

In another embodiment, the software includes voice synthesis code so that messages need only be stored as text (and thereby occupy less memory) . If a voice message is to be transmitted in response to an incoming call, the voice synthesis code converts the selected message block (i.e. stored in memory 32 effectively in text form) to an audio format for transmission, again as described above.

Further, as alluded to above, the software includes a selectable mode of operation (activated by means of the menu key 14a of the telephone 10) to allow the user to select more than one message block for transmission before effecting that transmission. Thus, the user can concatenate a plurality of message blocks into a larger message by depressing the appropriate sequence of keys on keypad 12. The concatenation process is terminated either by depressing a key assigned to indicate “end-of-message”, or after a delay greater than specified value. For example, the “1” key might have assigned to it the message block: “I can't speak now”; the “2” key may have assigned to it the message block: “I'm in a meeting”, while the “3” key may have assigned to it the message block: “I'm driving.” The user, in this mode of operation, could then—when he or she receives a call while in a meeting—depress “1” then “2” in rapid succession. When the telephone 10 detects no further key depression, the two messages are transmitted in concatenated form as: “I can't speak now I'm in a meeting”.

As mentioned above, the user stores message blocks in the form of words or phrases against each of the 12 keys of the keypad 12 to enable those messages to be transmitted to the caller or person who sends a text message without the need to utter the physical words during the ensuing “conversation”. In the case of voice message blocks, this process is comparable to existing techniques for saving brief audio messages for use in voice activated dialing; text message blocks can be saved to a dedicated text message folder that is otherwise—from the point of view of the user—conventional. In both cases, the various message blocks are assigned to specific keys of keypad 12 in the same manner as, in conventional systems, individual telephone numbers are assigned to keys for speed dialing.

The storage of a text message block (whether for transmission as a text message or—by means of the voice synthesis code—as an voice message) is thus effected as follows:
1. user depresses on menu key 14a;
2. user selects “Silent Speech” menu entry;
3. user selects “New Text Message Block”;
4. user selects “enter”.
5. user types word or phrase; and
6. user selects “enter” to save the message block.

The storage of a voice message block is effected as follows:
1. user depresses on menu key 14a;
2. user selects “Silent Speech” menu entry;
3. user selects “New Voice Message Block”;
4. user selects “enter”;
5. user selects “record”;
6. users speaks the phrase or word into the microphone 18; and
7. user selects “enter” to end and save the message block.

The new message block is thus saved to memory 32, and all saved messages blocks can subsequently be displayed alphabetically by the user, for editing, deletion, etc.

Message blocks can also be stored in memory 32 by downloading such message blocks from an online library of message blocks, much as are ring tones in conventional systems. These downloaded message blocks may be of any type, including audio, text, video and multimedia. Further, downloaded message blocks—particular voice message blocks—may be recorded by or imitate well known people.

In another embodiment, rather than assigning each message block to a key, the software controls the telephone 10 when an incoming call or text message is detected by displaying an alphabetical list of stored message blocks. This list can be displayed either automatically or in response to the user depressing a key assigned for this purpose, termed the “silent speech” key. By any suitable index searching algorithm or scrolling technique, the user locates the desired message block and then depresses “enter”. The software then operates as described above. If two versions of a message block are stored (one as text, the other as audio), the user can be presented additionally with the alternate option “say” so that the user can select “enter” if the text version is to be transmitted, or “say” if the audio version is to be transmitted.

Modifications within the scope of the invention may be readily effected by those skilled in the art. It is to be understood, therefore, that this invention is not limited to the particular embodiments described by way of example hereinabove.

In the claims that follow and in the preceding description of the invention, except where the context requires otherwise owing to express language or necessary implication, the word “comprise” or variations such as “comprises” or “comprising” is used in an inclusive sense, i.e. to specify the presence of the stated features but not to preclude the presence or addition of further features in various embodiments of the invention.

Further, any reference herein to prior art is not intended to imply that such prior art forms or formed a part of the common general knowledge.

1. A communications apparatus, comprising:
a memory for storing message data comprising a plurality of predefined message blocks;
a data processor in data communication with said memory; and
a program executable by said data processor to retrieve any of said predefined message blocks and to control said apparatus to transmit a message block so retrieved;
wherein said program is controllable by a user to select at least one of said predefined message blocks and to transmit or initiate transmission of the selected at least one message block.

2. An apparatus as claimed in claim 1, wherein said program is operable by said user when an incoming call or message is received by said apparatus to transmit a response to said incoming call or message comprising said selected message block.

3. An apparatus as claimed in claim 1, wherein said program is operable to initiate a call.

4. An apparatus as claimed in claim 1, wherein said communications apparatus is a portable communications device.

5. An apparatus as claimed in claim 1, wherein said apparatus is a mobile telephone, a personal digital assistant or a camera.

6. An apparatus as claimed in claim 1, wherein said program is operable by said user to select and transmit a plurality of said predefined message blocks in response to an incoming call or message.

7. An apparatus as claimed in claim 1, wherein said predefined message blocks are in the form of audio message data so that, when transmitted, said selected message block is audible to a recipient of said selected message block.

8. An apparatus as claimed in claim 1, wherein said predefined message blocks are in the form of text message data so that, when transmitted, said selected message block is received as a text message.

9. An apparatus as claimed in claim 1, wherein said predefined message blocks include both audio message data and text message data so that, when transmitted, said selected message block is received as both an audible message and as a text message.

10. An apparatus as claimed in claim 1, wherein said selected message block is received as a text message, a video message or a mixed media message.

11. An apparatus as claimed in claim 1, wherein said program includes voice synthesis code for interpreting message blocks, synthesizing a synthesized voice message therefrom and controlling said apparatus to transmit said synthesized voice message.

12. An apparatus as claimed in claim 1, wherein at least one of said predefined message blocks comprises or includes additional message data.

13. An apparatus as claimed in claim 1, wherein said apparatus has user operable keys and is controllable by means of said keys, whereby a respective one of said predefined message blocks is retrievable in response to operation of a respective one of said keys or a respective combination of said keys.

14. An apparatus as claimed in claim 1, wherein said apparatus is operable by a user to store said predefined message blocks in said memory.

15. An apparatus as claimed in claim 18, wherein said predefined message blocks are in the form of text message blocks, in the form of audio message blocks or in the form of video message blocks.

16. An apparatus as claimed in claim 1, wherein said program is operable by said user while said apparatus is announcing an incoming call.

17. An apparatus as claimed in claim 16, wherein said apparatus is operable by said user to answer said incoming call thereby establishing a telephony connection, and to transmit said response to said incoming call, whereby the maker of said incoming call receives said selected message block.

18. An apparatus as claimed in claim 17, wherein said apparatus is configured to terminate said telephony connection after said response has been transmitted to said maker of said call.

19. An apparatus as claimed in claim 1, wherein said program is operable by said user while and for a predefined period after said apparatus is announcing an incoming call or message.

20. An apparatus as claimed in claim 1, wherein said apparatus includes voice recognition software that is operable to convert any voice content of an incoming telephone call to text for display by said apparatus.

21. A communications apparatus, comprising:
a memory for storing message data comprising a plurality of predefined message blocks; and
a data processor in data communication with said memory;
wherein said apparatus is operable by a user to retrieve at least one of said predefined message blocks and to transmit the selected at least one message block.

22. A communications system, comprising:
a memory for storing message data comprising a plurality of predefined message blocks; and
a data processor in data communication with said memory;
wherein said system is operable by a user to retrieve at least one of said predefined message blocks and to transmit the selected at least one message block.

23. A method of transmitting a message from a communications apparatus, comprising:
storing message data comprising a plurality of predefined message blocks in a memory of said apparatus; and
selecting at least one of said predefined message blocks; and
controlling said apparatus to retrieve and transmit said selected predefined message block.

24. A method as claimed in claim 23, including activating said apparatus when an incoming call or message is received by said apparatus and transmitting a response to said incoming call or message comprising said selected predefined message block.

25. A method as claimed in claim 23, including initiating a call.

26. A method as claimed in claim 23, including selecting and transmitting a plurality of said predefined message blocks in response to an incoming call or message.

27. A method as claimed in claim 23, including storing said message data in the form of audio message data, in the form of text message data or in the form of video message data.

28. A method as claimed in claim 23, including converting said selected predefined message block into a synthesized voice message and transmitting said synthesized voice message.

29. A method as claimed in claim 23, including retrieving a respective one of said predefined message blocks by operating a respective one of said keys or a respective combination of said keys.

30. A method as claimed in claim 23, including a user storing said predefined message blocks in said memory.

31. A method as claimed in claim 23, including selecting said predefined message block and controlling said apparatus to retrieve and transmit said selected predefined message block while said apparatus is announcing an incoming call.

32. A method as claimed in claim 23, including answering an incoming call and thereby establishing a telephony connection, and transmitting a response to said incoming call whereby the maker of said incoming call receives said selected message block.

33. A method as claimed in claim 32, including automatically terminating said telephony connection after said response has been transmitted.

34. A computer program product loadable into the internal memory of a communications apparatus, comprising software code portions for performing the steps of the method of claim 23 when said product is run on said apparatus.

35. A computer program product stored on a computer readable medium for causing a communications apparatus to perform the steps of the method of claim 23.

36. A computer readable medium, having a program recorded thereon, where the program is adapted to make a communications apparatus execute a method as defined in claim 23.
